(19) United States
(12) Patent Application Publication
(10) Pub. No.: US 2017/0369105 A1
(43) Pub. Date: Dec. 28, 2017

(54) SYSTEM AND METHOD FOR JOINING PLASTIC COMPONENTS

(71) Applicant: GM Global Technology Operations LLC, Detroit, MI (US)

(72) Inventor: Thomas J. Pickett, Warren, MI (US)

(21) Appl. No.: 15/191,716

(22) Filed: Jun. 24, 2016

(51) Int. Cl. B62D 29/04; B29C 65/56; B29C 65/00; B29C 65/06; B29C 65/08; B62D 35/00; B29K 623/00; B29K 655/02; B29K 696/04; B29L 31/30

(52) U.S. Cl. CPC B62D 29/043; B29C 65/08; B29C 65/562; B29C 66/304; B29C 66/712; B62D 35/007; B29C 65/0681; B29K 2625/08; B29K 2655/02; B29K 2696/04; B29L 2031/3058; B29K 2623/00

(57) ABSTRACT

An automotive vehicle includes a body with a front portion and a rear portion. The vehicle additionally includes a spoiler coupled to the rear portion. The spoiler includes a first portion, a second portion, and a cap. The first portion includes a first plastic material, the second portion includes a second plastic material, and the cap includes a third plastic material. The second plastic material is distinct from the first plastic material. The second portion is disposed between the first portion and the cap. The second portion has a through hole extending therethrough. The cap has a diameter exceeding that of the through hole. The first portion and the cap are welded together via the through hole to mechanically secure the second portion to the first portion.

### TECHNICAL FIELD

The present disclosure relates to a system and method of joining plastic components, particularly for assembling a component for an automotive vehicle, and most particularly for assembling a two-piece rear spoiler for an automotive vehicle.

### INTRODUCTION

An automotive spoiler refers to an aerodynamic device designed to spoil undesirable air flow across the body of a vehicle. Many vehicles may include a so-called rear spoiler positioned near the top of the rear of the vehicle, e.g. in the vicinity of a vehicle trunk. The rear spoiler is generally provided to reduce drag and, in turn, increase fuel efficiency. However, spoilers may also be provided for stylistic purposes.

### SUMMARY

An automotive vehicle according to the present disclosure includes a body having a front portion and a rear portion. The vehicle additionally includes a spoiler coupled to the rear portion. The spoiler includes a first portion, a second portion, and a cap. The first portion includes a first plastic material, the second portion includes a second plastic material, and the cap includes a third plastic material. The second plastic material is distinct from the first plastic material. The second portion is disposed between the first portion and the cap. The second portion has a through hole extending therethrough. The cap has a diameter exceeding that of the through hole. The first portion and the cap are welded together via the through hole to mechanically secure the second portion to the first portion.

According to various embodiments, the first portion defines an upper surface of the spoiler and the second portion defines a lower surface of the spoiler.

A variety of plastic materials may be used. According to various embodiments, the first plastic material comprises ABS, ABS+PC, ASA, or ASA+PC; the second plastic material comprises TPO, and/or the third plastic material comprises ABS, ABS+PC, ASA, or ASA+PC. The third plastic material may be distinct from the first plastic material. In an exemplary embodiment, the second plastic material is not weld-compatible with the first plastic material, and the third plastic material is weld-compatible with the first plastic material.

A method of manufacturing a spoiler for a vehicle according to the present disclosure includes providing a first component, a second component, and a cap. The first component includes a first plastic material, the second component includes a second plastic material, and the cap includes a third plastic material. The second plastic material is distinct from the first plastic material. The second spoiler component has at least one through hole extending therethrough. The diameter of the cap exceeds that of the through hole. The method additionally includes assembling the cap over the hole. The method further includes welding the cap to the first spoiler component through the hole to mechanically secure the second spoiler component to the first spoiler component.

According to various embodiments, welding the cap includes ultrasonic welding or vibrational welding.

According to various embodiments, the first component includes a first spoiler component and the second component includes a second spoiler component.

An apparatus according to the present disclosure includes a first plastic component, a second plastic component, and a cap. The first plastic component has a first material composition, the second plastic component has a second material composition, and the cap has a third material composition. The second material composition is weld-incompatible with the first material composition, and the third material composition is weld-compatible with the first material composition. The second plastic component has at least one through hole extending therethrough, and is disposed between the first component and the cap. The first component and the cap are welded together via the through hole. Thus the second component is mechanically secured to the first component.

According to various embodiments, the first component includes an upper spoiler component and the second component includes a lower spoiler component.

According to various embodiments, the third material composition is distinct from the first material composition. The first material composition may include ABS or ABS−PC. The second material composition may include TPO. The third material composition may include ABS, ABS−PC, ASA, or ASA−PC.

Embodiments according to the present disclosure provide a number of advantages. For example, systems and methods according to the present disclosure enable the assembly, by welding, of dissimilar plastic materials having differing properties. Particularly advantageously, such systems and methods may be used to assemble a two-piece spoiler having an upper portion with a different material composition than a lower portion, where the upper portion is weld-incompatible with the lower portion.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is an illustration of a vehicle having a spoiler;

FIG. 2 is an illustration of a spoiler according to the present disclosure;

FIGS. 3A-3C are schematic illustrations of a method of assembling a spoiler according to the present disclosure; and

FIG. 4 is a flowchart representation of a method of assembling plastic components according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

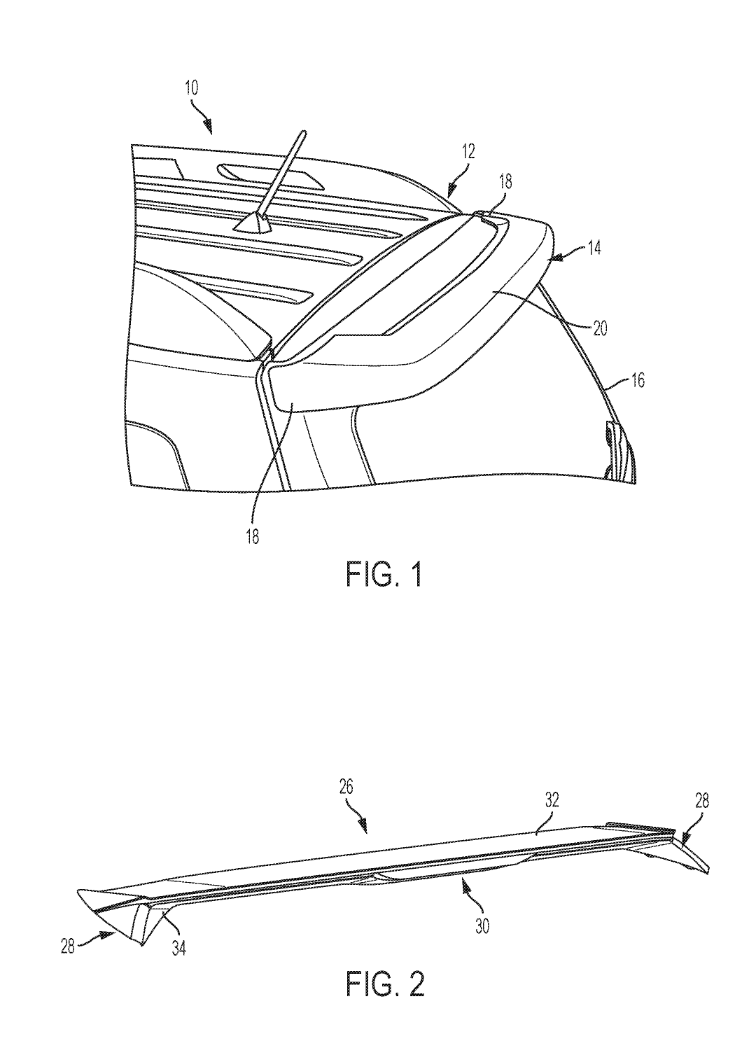

Referring now to FIG. 1, a rear portion 12 of a vehicle 10 is shown. A spoiler 14 is provided at the rear portion 12 above a vehicle trunk 16. The spoiler includes first and second mounting portions 18 for coupling to the vehicle 10 with an aerodynamic portion 20 therebetween. The spoiler 14 may be designed to provide advantageous aerodynamic characteristics and/or for vehicle styling.

In known designs, a spoiler is made using a single material, as a single piece or as multiple pieces chemically bonded to one another. Typically the single material is a plastic, such as ABS plastic, which is subsequently painted.

However, for various reasons it may be desirable to form the spoiler out of multiple components of differing materials. For example, it may be aesthetically appealing to generate a visual contrast by providing an upper portion of the spoiler with one color and/or texture and a lower portion of the spoiler with another color and/or texture.

While differing colors and/or textures for different portions may be technically achievable using a consistent material for the upper portion and lower portion, it may be prohibitively expensive to do so while maintaining desired characteristics.

For example, differing paints may be used on the upper portion and lower portion to achieve a desired aesthetic effect. However, it may be difficult or unnecessarily expensive to paint an upper portion in one color and paint a lower portion in another color.

As another example, one portion may be left unpainted to achieve a different color and/or texture. However, it may be undesirable to leave a portion unpainted, because typical ABS plastics are not weatherable, e.g. the color of the unpainted material may degrade when exposed to sunlight. While weatherable plastic materials may be used, they are generally more expensive, and forming a complete spoiler out of a weatherable material and subsequently painting over a portion of the material may incur unnecessary expense.

Other possible motivations to form the spoiler out of multiple components of differing materials include a desire to form one portion of the spoiler out of material having different structural properties than another portion.

However, while it may be desirable to form a spoiler out of multiple materials, it may be challenging to join different materials together to form the spoiler using known methods. Different materials may not be weld-compatible, i.e. the different materials may not be chemically bonded via a welding process. As a further consideration, spoilers for automotive vehicles are generally relatively thin aerodynamic components, and as such it may be difficult to implement fasteners to couple multiple components to form a spoiler.

Referring now to FIG. 2, a spoiler 26 according to the present disclosure is shown. The spoiler 26 has first and second mounting portions 28 for securing to a vehicle. The spoiler 26 includes an elongate aerodynamic portion 30 extending between the first and second mounting portions 28.

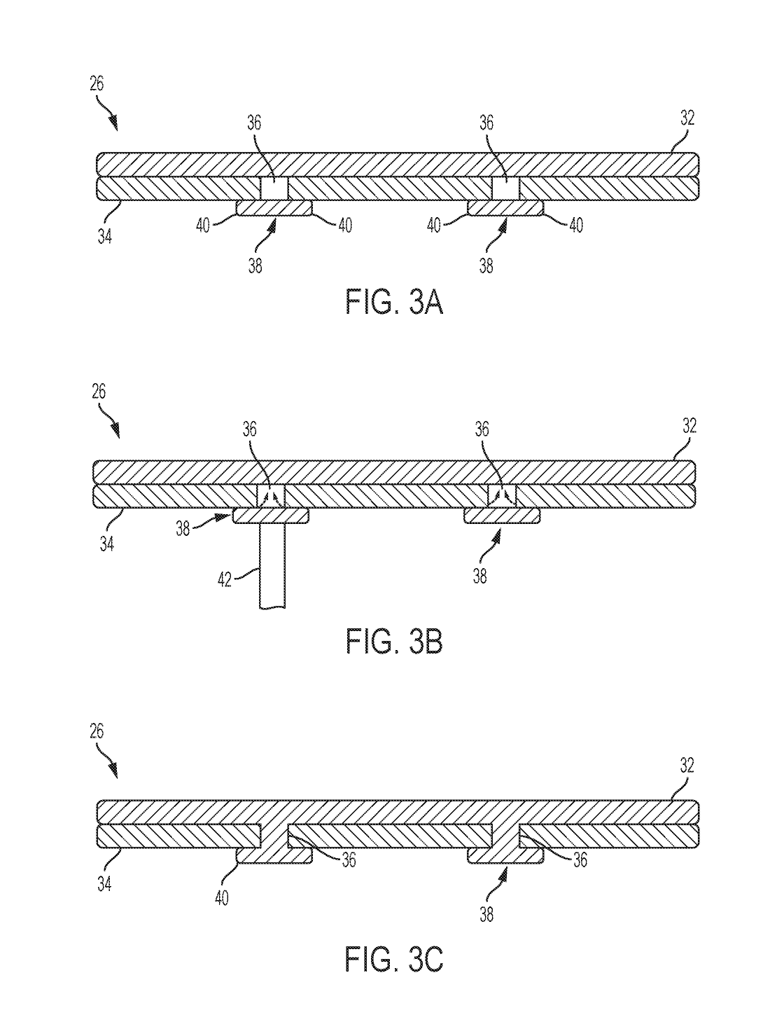

The spoiler 26 includes an upper component 32 and a lower component 34. The upper component 32 and the lower component 34 are distinct components formed of distinct materials which are weld-incompatible, i.e. are chemically incompatible such that they may not be joined by welding. In an exemplary embodiment, the upper component 32 is formed of a paintable material such as ABS, while the lower component 34 is formed of a weatherable color-in-mold material such as TPO. The upper component 32 and the lower component 34 are mechanically secured to one another by a weld between the upper component 32 and a cap (not shown in this view), as will be discussed below with respect to FIGS. 3A-3C.

Referring now to FIGS. 3A-3C, a method of assembling a spoiler 26 according to the present disclosure is illustrated schematically. The spoiler 26 includes the upper component 32 and the lower component 34. The lower component 34 includes at least one through hole 36. According to various embodiments, the holes 36 may be molded into the lower component 34 or provided by machining after molding. As shown in FIG. 3A, the lower component 34 is assembled in a desired position relative to the upper component 32. At least one cap 38 is disposed proximate the holes 36. In this exemplary embodiment, each cap 38 is associated with a single hole 36. However, in alternative embodiments, a single cap may be associated with multiple holes 36. The cap 38 has a width that exceeds a width of the associated hole or holes 36. The cap 38 is positioned to cover the hole 36, e.g. with protruding portions 40 positioned to abut the lower component 34 about the periphery of the hole 36.

As illustrated in FIG. 3B, a welding tool 42 is applied to the cap 28. The welding tool 42 is configured to apply heat and pressure to the cap 38. Under application of the welding tool, the plastic material of the cap 38 is heated through the glass transition. The plastic material of the cap 38 then flows into the hole 36 of the lower component 34, as illustrated by the arrows. The plastic material of the cap 38 contacts the upper component 32, and the molecules mix through intermolecular diffusion, forming a chemical bond between the cap 38 and upper component 32.

In exemplary embodiments, the welding tool 42 is a friction welding tool or a vibration welding tool. However, other welding techniques and/or other tools for applying heat and pressure may also be used.

As illustrated in FIG. 3C, the application of the welding tool 42 is discontinued, and the plastic material of the cap 38 is allowed to cool through the glass transition. The cap 38 is thus chemically bonded to the upper component 32. The protruding portions 40 of the caps 38 retain the lower component 34 in the desired position relative to the upper component 32. Thus, the lower component 34 is mechanically secured to the upper component 32.

In an exemplary embodiment, the caps 38 are positioned in a section of the lower component 34 which is hidden from sight when installed on a vehicle, thus improving aesthetic appeal of the spoiler 26.

While the above joining method is illustrated with respect to the exemplary embodiment of assembling a spoiler, other embodiments within the scope of the disclosure include assembly of other components, including other automotive and non-automotive applications.

Embodiments according to the present disclosure may be used to assemble a first plastic component and a second plastic component, where the first plastic component and second plastic component have different material compositions, e.g. are weld-incompatible, by welding the first plastic component to a plastic cap. According to various embodiments, the first plastic component and the second plastic component both include thermoplastic material, or the second plastic component may include thermoset material. According to various embodiments, the first plastic component and the second plastic component have differing melting temperatures. According to various embodiments, the cap is formed of the same material as the first plastic component, or a different material that is weld-compatible with the first plastic component.

As non-limiting examples, the first plastic component may include acrylonitrile butadiene styrene (ABS), ABS-polycarbonate (ABS−PC), acrylonitrile styrene acrylate (ASA), or ASA-polycarbonate (ASA−PC); the second plastic component may include thermoplastic olefin (TPO); and the cap may include ABS, ABS−PC, ASA, or ASA−PC.

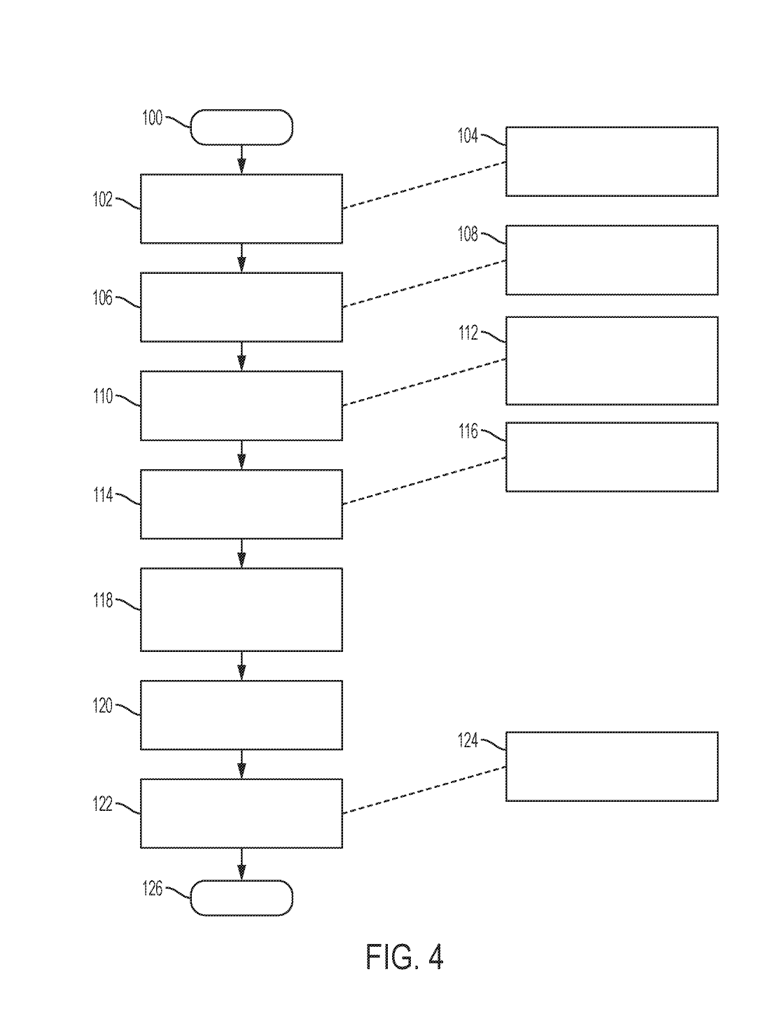

Referring now to FIG. 4, a method of assembling plastic components according to the present disclosure is illustrated in flowchart form. The algorithm begins at block 100.

A first plastic component is provided, as illustrated at block 102. The first plastic component is made of a first plastic material. The first material may include ABS or ABS−PC, as illustrated at block 104. The first plastic component may be a first component of a spoiler, as also illustrated at block 104.

A second plastic component is provided, as illustrated at block 106. The second plastic component is made of a second plastic material. The second material may include TPO, as illustrated at block 108. The second plastic component may be a second component of a spoiler, as also illustrated at block 108.

A cap is provided, as illustrated at block 110. The cap is made of a third plastic material. The third plastic material may be the same material as the first plastic material or it may be different from the first plastic material, as illustrated at block 112. The third material may include ABS, ABS−PC, ASA, or ASA−PC, as also illustrated at block 112.

A hole is provided in the second component, as illustrated at block 114. In various embodiments, the hole may be molded into the second component or machined after molding, as illustrated at block 116.

The second component is disposed in a desired position relative to the first component, as illustrated at block 118. In an exemplary embodiment where the first component is a first component of a spoiler and the second component is a second component of a spoiler, the first component may be superposed over the second component to form upper and lower portions of the spoiler, respectively.

The cap is assembled over the hole, as illustrated at block 120. In an exemplary embodiment, the cap is positioned in a location that would be hidden from view after assembly, e.g. to preserve a desired aesthetic effect.

The cap is welded to the first component via the hole, as illustrated at block 122. This may include friction welding or vibration welding, as illustrated at block 124. However, other welding techniques and/or other tools for applying heat and pressure may also be used.

The algorithm ends at block 126.

As may be seen, the present disclosure provides a system and method for joining, via welding, plastic components having different material compositions which are otherwise not weld-compatible. Advantageously, such systems and methods may be used to assemble a two-piece spoiler having an upper portion with a different material composition than a lower portion, thus providing pleasing aesthetic effects.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a body having an exterior portion; and
a spoiler coupled to the exterior portion, the spoiler including a first portion comprising a first plastic material, a second portion comprising a second plastic material, and a cap comprising a third plastic material, the second plastic material being distinct from the first plastic material, the second portion being disposed between the first portion and the cap and having a through hole, the first portion and the cap being welded together via the through hole to mechanically secure the second portion to the first portion.

2. The vehicle of claim 1, wherein the first portion defines an upper surface of the spoiler and the second portion defines a lower surface of the spoiler.

3. The vehicle of claim 1, wherein the first plastic material comprises ABS, ABS−PC, ASA, or ASA−PC.

4. The vehicle of claim 1, wherein the second plastic material comprises TPO.

5. The vehicle of claim 1, wherein the third plastic material comprises ABS, ABS−PC, ASA, or ASA−PC.

6. The vehicle of claim 1, wherein the third plastic material is distinct from the first plastic material and weld-compatible with the first plastic material.

7. A method of manufacturing a multi-piece plastic component, the method comprising:
providing a first component including a first plastic material;
providing a second component including a second plastic material, the second component having a hole extending therethrough, the second plastic material being distinct from the first plastic material;
providing a cap including a third plastic material;
assembling the cap over the hole; and
welding the cap to the first component via the hole to mechanically secure the second component to the first component.

8. The method of claim 7, wherein welding the cap comprises ultrasonic welding.

9. The method of claim 7, wherein welding the cap comprises vibrational welding.

10. The method of claim 7, wherein the third plastic material is distinct from the first plastic material and weld-compatible with the first plastic material.

11. The method of claim 7, wherein the first component is a first spoiler component and the second component is a second spoiler component.

12. The method of claim 7, wherein the first plastic material comprises ABS, ABS−PC, ASA, or ASA−PC.

13. The method of claim 7, wherein the second plastic material comprises TPO.

14. The method of claim 7, wherein the third plastic material comprises ABS, ABS−PC, ASA, or ASA−PC.

15. An apparatus comprising:
a first plastic component having a first material composition;
a second plastic component having a second material composition, the second material composition being weld-incompatible with the first material composition, the second plastic component having at least one through hole extending therethrough; and
a cap having a third material composition, the third material composition being weld-compatible with the first material composition, the second component being disposed between the first component and the cap, the first component and the cap being welded together via the through hole to mechanically secure the second component to the first component.

16. The apparatus of claim 15, wherein the first component includes an upper spoiler component and the second component includes a lower spoiler component.

17. The apparatus of claim 15, wherein the third material composition is distinct from the first material composition and weld-compatible with the first material composition.

18. The apparatus of claim 15, wherein the first material composition includes ABS, ABS−PC, ASA, or ASA−PC.

19. The apparatus of claim 15, wherein the second material composition includes TPO.

20. The apparatus of claim 15, wherein the third material composition includes ABS, ABS−PC, ASA, or ASA−PC.
